(19) United States
(12) Patent Application Publication
(10) Pub. No.: US 2011/0049892 A1
(43) Pub. Date: Mar. 3, 2011

(54) System For Efficient Energy Generation

(76) Inventor: Jonathan Ross, Fort Erie (CA)

(21) Appl. No.: 12/852,444

(22) Filed: Aug. 6, 2010

Related U.S. Application Data
(60) Provisional application No. 61/231,851, filed on Aug. 6, 2009.

(51) Int. Cl. H02P 9/04; H02K 47/14; H02K 53/00

(52) U.S. Cl. 290/50; 310/113; 415/916

(57) ABSTRACT

A system for generating energy may comprise a power source capable of supplying energy in the form of electricity to an electric motor. The electric motor is energized by the power source and will cause a drive shaft to rotate. The drive shaft is mechanically connected to an electric generator capable of converting the rotation of the drive shaft into electrical energy. A load may be electrically connected to the electric generator, such that the load may receive the electrical energy generated by electric generator.

### CROSS-REFERENCE TO RELATED APPLICATION

This application claims the benefit of priority to U.S. provisional patent application Ser. No. 61/231,851, filed on Aug. 6, 2010, now pending, the disclosure of which is incorporated herein by reference.

### FIELD OF THE INVENTION

The present invention relates generally to generating energy, and in particular, to efficiently generating energy using a mechanical linkage.

### BACKGROUND OF THE INVENTION

The need for a clean, renewable source of electrical power is readily apparent today. One of the many pressing needs is in the realm of residential domestic power generation. Many of the “off grid” systems rely on a battery pack, supplying power to the home via an inverter, and recharged by a fuel fed generator, wind generator, solar panels, or water generator.

Previous solutions are limited in that they are unable to regenerate themselves without the use of external energy sources such as fossil fuel, sun, wind, or water.

### BRIEF SUMMARY OF THE INVENTION

A system for generating energy may comprise a power source capable of supplying energy in the form of electricity to an electric motor. The electric motor is energized and will cause a drive shaft to rotate. The drive shaft is mechanically connected to an electric generator capable of converting the rotation of the drive shaft into electrical energy. A load may be electrically connected to the electric generator, such that the load may receive the electrical energy generated by the electric generator.

The power source may be a battery providing direct current (DC) power. The electric motor and/or the electric generator may be DC type or alternating current (AC) type. Invertors may be used to convert DC power to AC power.

The system may also comprise a rechargeable battery electrically connected to the electric generator. The system may further comprise a charge control for preventing overcharging a connected battery. The system may also comprise a motor control for selectively activating the electric motor only when power is needed.

In another embodiment of a system according to the present disclosure, a second electrical generator may be connected to the drive shaft. The first and second electrical generators may be connected in parallel or in series.

In another embodiment of a system according to another embodiment of the present disclosure, the drive shaft may further comprise a flywheel. In this manner, the flywheel may be rotated by the drive shaft in order to cause the flywheel to rotate at an optimum rotational frequency. The rotational frequency may be measured by a tachometer, which may supply a signal to a motor control to activate or deactivate the electric motor.

The current invention can recharge a battery pack without the need for fuel (fossil or otherwise), wind, sun, or water. Another object of the invention is to provide a standalone power supply for electronic devices, such as computers or communications equipment used in remote areas over a long period of time. In addition, since the units can be joined to create more powerful systems, they may be used as auxiliary charging units for vehicles such as road vehicles, trains, or watercraft. The current invention describes standalone electrical energy generation systems which can be used in any situation where a portable power source is needed.

### DESCRIPTION OF THE DRAWINGS

For a fuller understanding of the nature and objects of the invention, reference should be made to the following detailed description taken in conjunction with the accompanying drawings, in which:

FIG. 1 is a schematic of a system according to an embodiment of the invention;

FIG. 2 is a schematic of one type of motor control;

FIG. 3a is a schematic of another embodiment of the invention wherein two generators are connected in series;

FIG. 3b is a schematic of another embodiment of the invention wherein two generators are connected in parallel;

FIG. 4 is a schematic of another embodiment of the invention having a flywheel; and

FIG. 5 is a graph showing battery charge and depletion cycles.

### DETAILED DESCRIPTION OF THE INVENTION

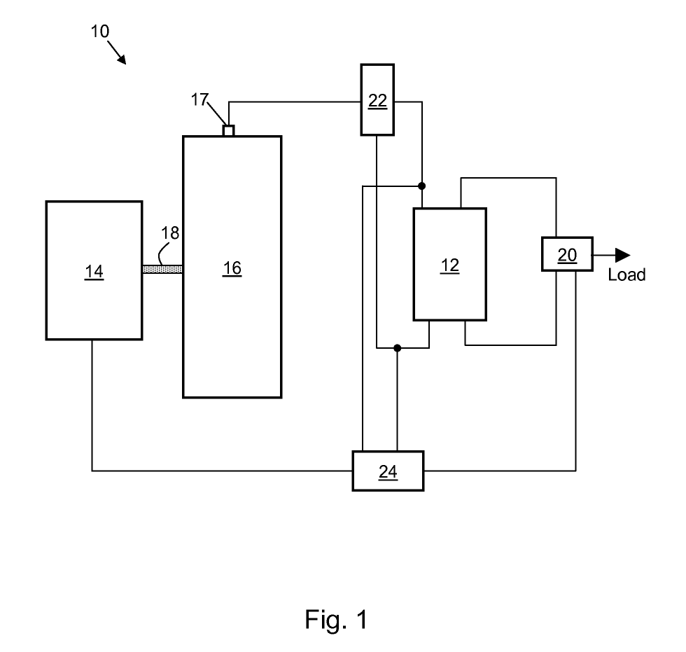

FIG. 1 depicts a system 10 for generating energy according to the present disclosure. A power source 12 (depicted as a battery in FIG. 1), which is capable of supplying energy in the form of electricity, is provided. Power source 12 is electrically connected to an electric motor 14. In this way, power source 12 provides electrical energy to electric motor 14. The electric motor 14 is thus energized and will cause a drive shaft 18 of the electric motor 14 to rotate about a longitudinal axis.

Drive shaft 18 is mechanically connected to an electric generator 16. Electric generator 16 is capable of converting the rotation of drive shaft 18 (mechanical energy) into electrical energy. The generated electrical energy is provided to electrical contacts of the electric generator. A load (not shown) may be electrically connected to the electrical contacts of the electric generator 16. As such, the load may receive the electrical energy generated by electric generator 16.

Power source 12 may be a battery, and may provide direct current (DC) power directly to a DC motor. Alternatively, a DC power source (such as, but not limited to, a battery) may provide DC power to an inverter which is capable of conditioning the DC power into alternating current (AC) power. In this manner, the electric motor may be an AC motor.

System 10 may also comprise a battery electrically connected to the electrical contacts 17 of the electric generator 16. In FIG. 1, power source 12 is a battery which is also connected to the electrical contacts 17 of the electric generator 16. In this manner, a portion of the electrical energy generated by the electric generator 16 may be used to recharge the battery power source 12, as the battery power source 12 is depleted in providing energy to the electric motor 14. Electric generator 16 is preferably sized to generate more power than is used by electric motor 14. As such, the gain provided by the mechanically connected electric motor 14/electric generator 16 combination, is sufficient to render the system 10 to be self-sufficient.

Electric generator 16 may be a DC generator, which may be directly connected to the battery 12 via the electrical contacts 17. An inverter 20 may be connected to the battery 12 in order to supply a load with AC power. Alternatively, electric generator 16 may be an AC generator, in which case an inverter is necessary between the electric generator 16 and the battery power source 12. System 10 may further comprise a charge control 22 for preventing overcharging the battery power source 12.

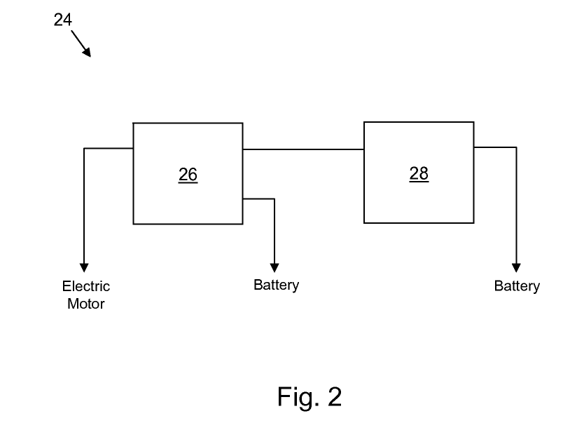

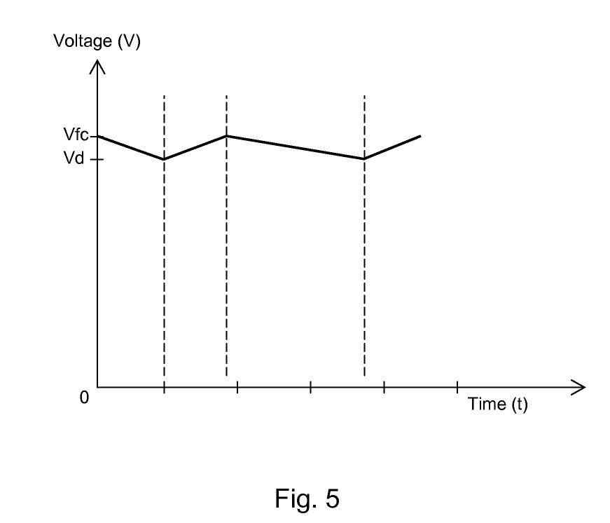

System 10 may also comprise a motor control 24 for selectively activating the electric motor 14 only when additional power is needed (e.g. when the battery power source has reached a depleted threshold). FIG. 2 schematically depicts one such motor control having a drive motor activation switch 26 and a battery charge monitor 28. FIG. 5 is a graph depicting the charge level of a battery power source 12. Battery level is initially at a full charge voltage (Vfc) and is depleted as a load draws power. When battery charge monitor 28 determines that the battery level has reached a depleted voltage (Vd), the drive motor activation switch 26 activates the electric motor 14 in order to generate electrical energy—thereby recharging the battery. As the battery recharges to Vfc (monitored by battery charge monitor 28), the drive motor activation switch 26 deactivates the electric motor 14, and the depletion cycle begins again. The length of time to discharge and/or recharge the battery may vary according to the load on the system 10.

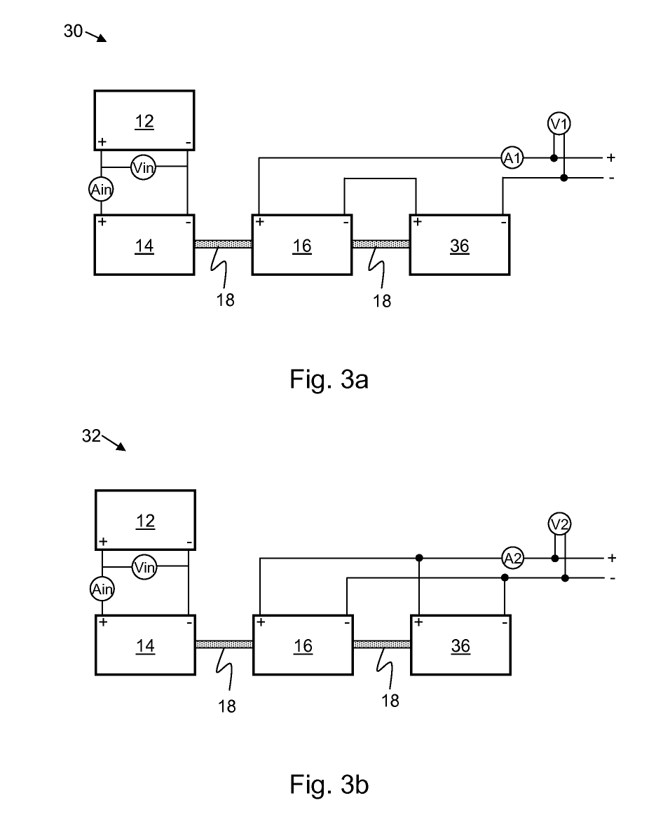

In another embodiment according to the disclosure, system 30 may comprise a second electrical generator 36 that is connected to the drive shaft 18 (see, e.g., FIG. 3a). The second generator 36 may be electrically connected to generator 16 such that the electrical contacts 17 of the electrical generators 16, 36 are in series, as depicted in FIG. 3a. As such, when similarly sized motors and generators are used, a voltage V1 measured at the combined output of the generators 16, 36 is roughly equal to two times a voltage Vin measured at the input of the electric motor 14 (while A1 is roughly equal to Ain). Alternatively, in the embodiment shown in FIG. 3b, the second generator 36 may be connected to generator 16 such that the electrical contacts 17 of the electric generators 16, 36 are in parallel, as depicted in FIG. 3b. As such, when similarly sized motors and generators are used, an amperage A2 measured at the combined output of the electrical generators 16, 36 is roughly equal to two times an amperage Ain measured at the input of the electric motor 14 (while voltage V2 is roughly equal to Vin).

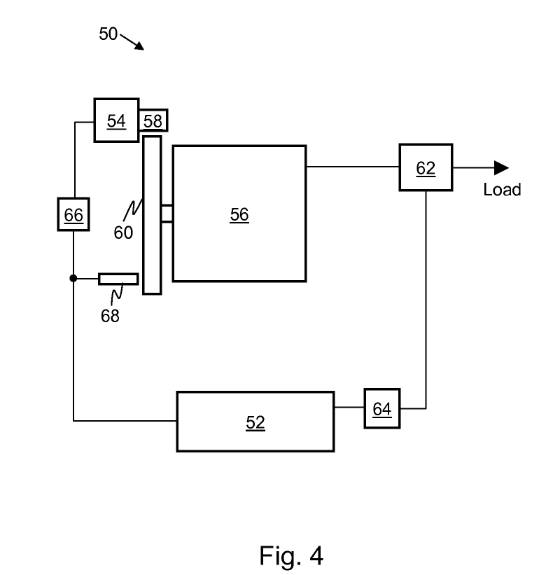

In a system 50 according to another embodiment of the present disclosure, drive shaft 58 further comprises a flywheel 60 (see, e.g., FIG. 4). The drive shaft 58 is connected to electric motor 54. The flywheel 60 is connected to electric generator 56. In this manner, the flywheel 60 may be rotated by the drive shaft 58 in order to cause flywheel 60 to rotate at an optimum rotational frequency (as determined by the specifications of the selected electric generator 56). The rotational frequency may be measured by a tachometer 68. In this manner, motor control 66 may receive a signal from tachometer 68, and may control the electric motor 54 only when the rotational frequency of the flywheel 60 is lower than the predetermined (sub-optimum) threshold. Drive shaft 58 may be caused to disengage from flywheel 60 once optimum rotational frequency has been achieved, and re-engage with flywheel 60 once flywheel has slowed down beneath a frequency threshold.

System 50 may further comprise a battery 52 which may be charged by the electrical generator 56. Charge control 62 may selectively direct a portion of the generated electrical energy to battery 52, in order to avoid over-charging the battery 52. Battery charge module 64 may further condition the generated electrical energy as appropriate for the type of battery 52.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A system for generating energy, comprising:
a power source for supplying electrical energy;
an electric motor having a drive shaft, the electric motor electrically connected to the power source such that the electric motor is energized by the power source; and
an electric generator mechanically connected to the drive shaft, wherein the electric generator has electrical contacts for providing generated electrical energy to a load.

2. The system of claim 1, wherein the electric motor is a DC motor.

3. The system of claim 1, wherein the electric generator is a DC generator.

4. The system of claim 3, further comprising a battery electrically connected to the electrical contacts of the electric generator such that the battery is charged by the generated electrical energy.

5. The system of claim 4, wherein the battery is electrically connected to the electric motor, creating a circuit such that the electric motor is energized by the battery.

6. The system of claim 5, further comprising a charge controller electrically connected between the battery and the generator such that the charge controller selectively allows generated electrical energy to charge the battery when the battery is not fully charged.

7. The system of claim 4, further comprising an inverter electrically connected to the battery, wherein the inverter converts DC power into AC power.

8. The system of claim 1, wherein the drive shaft further comprises a flywheel selectively driven by the electric motor and mechanically connected to the electric generator, such that the electric generator is driven by the flywheel.

9. The system of claim 8, further comprising a motor control having an input, the motor control being in communication with the electric motor, such that the motor control may selectively cause the electric motor to activate depending on a state of the input.

10. The system of claim 9, further comprising a tachometer operatively connected to the flywheel and in communication with the input of the motor control, such that the tachometer measures the rotational frequency of the flywheel and provide a signal to the input of the motor control.

11. The system of claim 1, further comprising a second electric generator mechanically connected to the drive shaft, wherein the second electric generator has electrical contacts for providing generated electrical energy to a load.

12. The system of claim 11, wherein the electrical contacts are connected in series.

13. The system of claim 11, wherein the electrical contacts are connected in parallel.
